(19) United States
(12) Patent Application Publication
(10) Pub. No.: US 2010/0030803 A1
(43) Pub. Date: Feb. 4, 2010

(54) METHOD FOR GENERATING BUSINESS INTELLIGENCE

(76) Inventors: Erik Rothenberg, Playa Del Ray, CA (US); Kevin Goldberg, Westlake Village, CA (US); William J. Salak, Newbury Park, CA (US); Jeannette Draper, Venice, CA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 12/579,621

(22) Filed: Oct. 15, 2009

Related U.S. Application Data
(63) Continuation-in-part of application No. 12/182,561, filed on Jul. 30, 2008.

(51) Int. Cl. G06F 17/30

(52) U.S. Cl. 707/102; 707/E17.044; 707/E17.045

(57) ABSTRACT

A method for generating business intelligence comprising the steps of creating a database, contributing data into the database via a computer, assigning numeric values to the data via the computer and calculating scores from the data. The data is selected from agenda, statements, subject types and attributes. The agendum is an objective. The statements support the agendum. The subject types comprise a category of a person, place or object. The attributes describe the subject types and may comprise attribute value descriptions and attribute value inputs. All the data is inputted into a software program, and the software program is utilized to calculate a holistic agendum score or a normalized agendum score. The holistic agendum score is a numerical indicator of the agendum based on holistic calculations and the normalized agendum score is a numerical indicator of the agendum based on zero-based cross normalization calculations.

### CROSS-REFERENCE TO RELATED APPLICATIONS

The present application is a continuation-in-part of, and claims priority to and full benefit of, non-provisional patent application Ser. No. 12/182,561, entitled “METHOD FOR GENERATING A COMPUTER-PROCESSED FINANCIAL TRADABLE INDEX,” filed on Jul. 30, 2008, the entire contents of which are hereby incorporated by reference. The present application is related to non-provisional patent application Ser. No. 12/275,550, entitled “METHOD FOR MODIFYING THE TERMS OF A FINANCIAL INSTRUMENT”, filed Nov. 21, 2008, the entire contents of which are hereby incorporated by reference.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to a method for generating business intelligence, and more specifically to a method for generating business intelligence comprising the steps of creating a database, contributing data into the database via a computer, assigning numeric values to the data via the computer and calculating scores from the data, wherein the scores are representative of the data.

2. Description of Related Art

Methods and systems exist today which measure subject performance relative to an agendum, or goal. Examples of this type of system include the Dow Jones Industrial Average (DJIA), Standard & Poor's (S&P 500), Price to Earnings Ratio (P/E), and Earning per Share (EPS) systems.

The scores produced by the DJIA and S&P 500 indexes intend to reflect the state of the stock market at a given point in time. These indexes are single subject performance scores which use a selection of stocks as data points or key performance indicators to measure holistic stock market movement and relate holistic stock market performance.

The scores produced by the DJIA and S&P 500 indexes, and systems which use a single subject performance scoring model are valuable as a method for comparing the performance of a single subject against the same subject. For example, to say “the DJIA is up 100 points today” is a statement which conveys meaningful information about the performance of the stock market based upon the comparison of the state of the DJIA index at different points in time. The scores produced by the P/E and EPS ratios intend to reflect the valuation of a stock at a given point in time. These scores are multi-subject performance scores which use a fixed set of data points or key performance indicators that are used to measure more than one subject.

The scores produced by the P/E and EPS ratios, and systems which use a multi-subject performance scoring model are valuable as a method for comparing the performance of one or more subjects against one or more different subjects. For example, to say “this week of trading closed with MSFT P/E at 12.44 and AAPL P/E at 25.63” is a statement which conveys meaningful information about the relative value of two different stocks at a given point in time.

In prior art, methods and systems that create performance measurement scores and indexes are limited in the scope of their application. Existing single subject measurement systems are difficult to repurpose for the measurement of new subjects. Existing multi-subject measurement systems are restricted to measuring subjects, which contain the same set of data points or key performance indicators. Tight coupling of data points or key performance indicators with the subject and/or subject type being measured restricts the ability to reuse these methodologies to measure new subjects and/or subjects with different and/or conflicting data points or key performance indicators.

Therefore, it is readily apparent there is a need for a methodology, which can be implemented, within a single embodiment, to measure and produce a performance measurement score useful for comparison of two or more subjects with: similar data points with respect to a common agendum; disparate data points with respect to a common agendum; similar data points in categories of interest that exist subordinately to a common agendum; and/or disparate data points in categories of interest that exist subordinately to a common agendum.

### BRIEF SUMMARY OF THE INVENTION

Briefly described, in a preferred embodiment, the present invention overcomes the above-mentioned disadvantages and meets the recognized need for such an apparatus by providing a business intelligence system which uses a methodology and process for scoring subjects relative to an agendum, wherein the word “business” in “business intelligence system” refers to a collection of activities carried on for a specific purpose, for example without limitation, a scientific purpose, a technological purpose, a commercial purpose, an industrial purpose, a legal purpose, a governmental purpose, and the like, and wherein, the word “intelligence” in “business intelligence system” refers to the ability to understand the interrelationships of presented facts in such a way as to guide actions towards a desired agendum, and wherein the word “system” in “business intelligence system” refers to a regularly interacting group of items acting as a whole.

According to its major aspects and broadly stated, the present invention in its preferred form is a method for generating business intelligence comprising the steps of creating a database, contributing data into the database utilizing a computer, assigning numeric values to the data utilizing the computer and calculating scores from the data, in which the scores are representative of the data.

The database is in communication with the computer via a software program. The software program may access the database either locally on a computer or over the Internet. The data contributed comprise agenda, statements, subject types and/or attributes. The agendum is an objective and the statements support the agendum. The statements generate a statement taxonomy, which comprises parent statements and/or child statements. The top-level statements are derived from the agenda. Statements which derive other statements are called parent statements, and child statements are derived from parent statements. Statements sharing a common parent are grouped together to form peer groups. Similarly, child statements sharing a common parent statement may be grouped together to form child peer groups.

Statements in the statement taxonomy are assigned statement weights by the software program or by a user utilizing the software program. The statement weights for the statements in the parent and child peer groups (which summed equal one-hundred percent) are operated on mathematically to create statement weight totals.

The attributes generate a subject type taxonomy. Attributes comprise parent attributes and/or child attributes. Top-level attributes are derived from subject types. Attributes which derive other attributes are called parent attributes. Attributes sharing a common parent are grouped together to form parent attribute sets. Attributes in the subject type taxonomy are assigned attribute weights by the software program or by a user utilizing the software program. Attribute weights for attributes within attribute sets (which summed equal one-hundred percent) are operated on mathematically to create attribute weight totals.

Attributes may further comprise attribute value inputs, attribute value descriptions and/or attribute normalization scales. Attribute value inputs comprise attribute values, subject scores and/or attribute set scores. Attribute values comprise inputted and/or measured numerical indicators for selected attributes. Attribute value descriptions comprise indicia defining attribute values. Attribute normalization scales comprise ranges of acceptable numerical indicators inputted into the software program for selected attribute values. Subject scores comprise calculated scores for subject instances, which comprise occurrences of the subject types. Lastly, attribute set scores comprise calculated scores derived from attribute sets.

Additionally, the present invention is a method for generating business intelligence comprising the steps of entering an agendum into the software program, entering parent statements into the software program and entering child statements into the software program. The method further comprises the steps of selecting statements, linking selected statements into peer groups, assigning statement weights to the statements, and calculating statement weight totals for the peer groups. The agendum is common to the top-most statements. Likewise, parent statements are common to each of their selected child statements. In all cases, peer groups comprise at least two statements. The statement weights assigned to the statements are selected from data inputted by the user, data from the Internet and/or data previously stored in the software program. The statements within the peer groups are operated on mathematically to calculate statement weight totals.

The method further comprises the steps of entering subject types into the software program, entering top-level attributes into the software program and entering child attributes into the software program.

Additionally, the method comprises the steps of selecting attributes, linking the selected attributes into attribute sets having a common parent attribute and at least two of the selected child attributes, and assigning attribute weights to the attributes utilizing data inputted by the user, data from the Internet and/or data previously stored in the software program. The method also comprises the steps of calculating attribute weight totals for the attribute sets, which are operated on mathematically to calculate attribute weight totals.

The method further comprises the step of assigning attribute values for subject instances into the software program by a user. The attribute values are numerical indicators comprising inputted numeric values for the parent attributes and/or the child attributes. The subject instances comprise occasions of the subject types. The method further comprises the steps of assigning attribute values for the subject instances via the automatic crawling of the Internet by the software program and normalizing the attribute values through mathematical operations utilizing an attribute normalization scale to generate attribute scores. The attribute normalization scale is a range of acceptable numerical indicators inputted into the software program as the attribute values. The attribute scores are normalized numeric values for the parent and child attributes. Additionally, the method further comprises the steps of mathematically operating on the attribute scores of the attributes within the attribute sets to calculate attribute set scores. The attribute set scores are a singular calculated numeric value for the selected attribute sets.

The method further comprises the steps of calculating the attribute scores, calculating the attribute set scores, scanning for uncalculated attribute scores and uncalculated attribute set scores utilizing the software program, assigning the attribute values to the parent and child attributes with the uncalculated attribute scores, assigning the attribute values to the parent and child attributes within the attribute sets with uncalculated attribute set scores and mathematically operating on the attribute scores and the attribute set scores to calculate subject scores, which are calculated numeric values for the subject instances.

The method also includes the steps of selecting subject types, selecting statements, linking selected subject types to selected statements, in which the selected subject types comprise parent attributes and child attributes, and in which the parent attributes and the child attributes contribute their attribute scores, linking the selected subject types to the selected parent and child statements, in which selected subject types comprise attribute sets that contribute their attribute set scores and normalizing the attribute set scores linked to selected statements through mathematical operations utilizing statement weights to compute statement scores, which are calculated numeric values for selected statements. The statement scores of the statements within the peer groups are mathematically operated on to calculate peer group scores. The peer group scores are a singular calculated numeric value.

Additionally, the method further comprises the step of scanning for uncalculated statement scores and peer group scores utilizing the software program. The method further comprises the steps of selecting statements with uncalculated statement scores of selected peer groups with uncalculated peer group scores, excluding the selected statements of the selected peer groups, in which the software program ignores the selected statements and, performing holistic calculations utilizing the selected peer groups, in which the statement weights of the statements within the selected peer groups are proportionally re-adjusted to maintain the statement weight total of one-hundred percent, calculating the peer group scores and a calculating holistic agendum score. The holistic agendum score is a numerical indicator of the agendum based on the holistic calculations.

Lastly, the method further comprises the steps of selecting statements with uncalculated statement scores of selected peer groups with uncalculated peer group scores, including selected statements of selected peer groups if the statements are missing statement scores, in which the software program utilizes selected statements, performing zero-based cross normalization calculations utilizing the selected statements, in which the zero-based cross normalization calculations assign a neutral numeral to selected statements, and in which the neutral numeral is assigned to maintain the statement weight total of one-hundred percent, and calculating a normalized agendum score. The normalized agendum score is a numerical indicator of the agendum based on the zero-based cross normalization calculations.

More specifically, the present invention is a method for generating business intelligence comprising a software program and an agendum. The agendum is a goal and/or an objective and comprises statements. The statements refer to one or more declarative sentences which are organized hierarchically under the agendum and the statements are meant to support the agendum. The statements further comprise top-level statements, such as parent statements. The top-level statements are declarative sentences that beget other declarative sentences which are organized hierarchically under the agendum, and the top-level statements support the agendum. The top-level statements further comprise child statements. Child statements are declarative sentences that are preceded hierarchically by the top-level statements, which are their parent statements, and the child statements support their parent statements. The method for generating business intelligence further comprises statement taxonomy. The statement taxonomy is a relational hierarchy of the agendum and the statements. The statements are descendants of the agendum, and the agendum is at a statement taxonomy peak. The statement taxonomy comprises statement peer groups, such as child peer groups and parent peer groups. The peer groups comprise two or more child statements sharing a common parent statement, or alternatively, two or more parent statements sharing a common agendum. The statements within the statement taxonomy comprise statement weights. The statement weight total is a sum total of the statement weights of the statements within selected peer groups and equals one-hundred percent. It will be recognized by those skilled in the art that the statement taxonomy may comprise limitless parent statements and child statements. Additional parent statements and child statements each comprise individual statement weights and may comprise additional peer groups. Further, the child statements may branch from other child statements. Under these circumstances, the child statements are the parent statements to the child statements, while still maintaining the original hierarchy of the statement taxonomy.

The method for generating business intelligence further comprises subject types and subject instances. Subject types comprise a category of a person, place or thing. Subject instances are the manifestation of the subject types. The subject instances comprise attribute values. The attribute values are the actual collected and/or measured data for the selected attributes. The attributes further comprise top-level attributes, such as parent attributes. The top-level attributes are organized hierarchically under the subject types, and the subject types are supported by the top-level attributes. The attributes further comprise child attributes. The child attributes are preceded hierarchically by the top-level attributes, which are their parent attributes, and the parent attributes are supported by the child attributes. The method for generating business intelligence further comprises subject taxonomy. The subject taxonomy is a relational hierarchy of the subject types and the attributes. The attributes are descendants of the subject types, and the subject instances are manifestations of the subject types, and the top-level attributes are at the top of the subject taxonomy peak. The subject taxonomy comprises attribute sets, such as child attribute sets. The attribute sets are a group of two or more child attributes sharing a common parent attribute. The subject taxonomy further comprises a top-level attribute set, such as a parent attribute set. The top-level attribute set is a group of two or more top-level attributes sharing a common subject type. The subject types comprise the attributes, and the attributes comprise attribute value descriptions and attribute value inputs. The attributes may further comprise an attribute normalization scale. The attribute value descriptions represent the attribute values, and are text images, movies and/or other media known in the art through which the attribute values are defined. The attribute value inputs is an entry field, and are numeral values may be inputted within the software program for the attributes. The attribute value inputs may comprise attribute values, subject scores or attribute set scores. The subject scores are calculated scores for the subject instances. The attribute set scores are calculated scores for attribute sets. The attribute normalization scale is a range of acceptable numeral values inputted into the software program as the attribute values.

The attributes within the subject taxonomy comprise attribute weights. An attribute weight total is a sum total of the attribute weights of each attributes within selected attribute sets, and equals one-hundred percent. It will be recognized by those skilled in the art that the subject taxonomy may comprise limitless parent attributes and child attributes. The additional parent attributes and child attributes each comprise individual attribute weights and may comprise additional attribute sets. Further, child attributes may branch from other child attributes. Under these circumstances, the child attributes are parent attributes to the child attributes, while still maintaining the original hierarchy of the subject taxonomy. Additionally, the subject types may branch from other attributes. Under these circumstances, the attributes accept the subject scores as the attribute value, while still maintaining the original hierarchy of the subject taxonomy.

A user establishes the statement taxonomy via a utilizing the software program on a computer to access a database. The database may be stored off-line locally on the computer or on-line on the Internet. The computer, the database and the Internet are in communication. The user enters the agendum into the software program. The user then enters the top-level statements into the software program, in which the top-level statements relate to the agendum. Subsequently, the user inputs the child statements into the software program, in which the child statements relate to the top-level statements, and can input additional child statements into the software program, in which these child statements relate to the previously entered child statements. Accordingly, such inputs collectively create the hierarchically order of the statement taxonomy with respect to the agendum. Thus, the statements that directly support the agendum are classified as the top-level statements, and the statements that support parent statements are classified as child statements.

The software program automatically groups two or more child statements linked to common parent statements into peer groups. Similarly, the software program automatically groups two or more top-level statements linked to the agendum into peer groups. The software program then assigns the statement weights to the statements. The statement weights may be assigned by the software program through autonomous calculations conducted by an artificial intelligence script or alternatively though manual input of the user. The statement weight total is then calculated for the peer groups. The statement weights may comprise data inputted by the user, data gathered from the software program utilizing information previously stored in the software program and/or data gathered from the Internet. It will be recognized by those skilled in the art that the statement weights may be obtained from other sources, such as, for exemplary purposes only, through community voting methods.

A user establishes subject taxonomy via a process which requires utilizing the software program on the computer to access the database. The database may be stored off-line locally on the computer or on-line on the Internet. The computer, the database and the Internet are in communication. The user enters the subject types into the software program. Subsequently, the user inputs the top-level attributes into the software program, and the top-level attributes relate to the subject types. The user then inputs the child attributes into the software program, in which the child attributes relate to the top-level attributes, and can input additional child attributes into the software program, in which these child attributes relate to the previously entered child attributes Thus, the user collectively creates the hierarchically order of the subject taxonomy with respect to the subject types. The attributes that directly support the subject types are classified as top-level attributes, and the attributes that support parent attributes are classified as child attributes.

The software program automatically groups two or more child attributes linked to a common parent attribute into attribute sets. Similarly, the software program automatically groups two or more top-level attributes linked to a common subject type into attribute sets. The software program then assigns the attribute weights to the attributes. The attribute weight total is calculated for the attribute sets. The attribute weights may comprise data inputted by the user, data gathered from the software program utilizing information previously stored in the software program and/or data gathered from the Internet. It will be recognized by those skilled in the art that the attribute weights may be obtained from other sources, such as, for exemplary purposes only, community voting methods.

The user assigns collected or measured attribute values for the subject instances into the software program. Alternatively, the software program automatically crawls the Internet to augment selected attribute values with newly updated data. Subsequently, the attributes values are normalized via the attribute normalization scale, thereby creating the attribute scores. The attribute scores of the attributes within the attribute sets are then, for exemplary purposes only, summed together to create attribute set scores. The attribute set scores are a singular value that defines all the attributes within selected attribute sets.

The software program calculates all attribute scores of the attributes and all the attribute set scores of all the attribute sets. The attribute scores and the attribute set scores are linked to selected subject instances. The software program scans the subject taxonomy for uncalculated attribute scores and uncalculated attribute set scores of the selected attributes or of the selected attribute sets. If uncalculated attribute scores or uncalculated attribute set scores are detected, then the software program selectively assigns the attribute values to the attributes with the uncalculated attribute scores or the uncalculated attribute set scores. If no uncalculated attribute scores and attribute set scores are detected, then the software program utilizes selected attribute scores and selected attribute set scores to calculate the subject scores, and a plurality of mathematical calculations may be applied to the selected attribute scores and the attribute set scores, such that the subject scores are numerical assessments computed for particular subject instances.

The user may selectively utilize the software program to link the selected attributes of the subject types to the selected statements, in which the attribute set scores linked to the statements are normalized through, for exemplary purposes only, multiplying by the statement weights to compute the statement scores. The statement scores of the statements within the peer groups are then, for exemplary purposes only, summed together to calculate peer group scores. The peer group scores are a singular value that defines all the statements within the selected peer groups.

The software program calculates all statement scores of the statements and all peer group scores of all peer groups, and the statement scores and the peer group scores are linked to a selected agendum. The software program scans the statement taxonomy for uncalculated statement scores. If no uncalculated statement scores are detected, then the software program utilizes the selected statement scores and the selected peer group scores to calculate a first agendum score. A plurality of mathematical calculations may be applied to the selected statement scores and the peer group scores starting from the statements or the child and/or parent peer groups furthest from the statement taxonomy peak. The first agendum score is a numerical assessment computed for a particular agendum. Alternatively, if the statements of the peer groups do not contain statement scores, then the software program selectively performs holistic calculations. Holistic calculations exclude the statements that do not originally contain statement scores. Accordingly, the statement weights of the remaining statements within selected peer groups are proportionally re-adjusted to maintain the statement weight total of one-hundred percent for the peer groups. Subsequently, the peer group scores are re-calculated, and the software program calculates the holistic agendum score. The holistic agendum score is calculated by applying a plurality of mathematical calculations to all statement scores and peer group scores starting from statements or the peer groups furthest from the statement taxonomy peak. The holistic agendum score is an adjusted numerical assessment computed for a particular agendum. Alternatively, if the statements of peer groups do not contain statement scores, then the software program selectively performs zero-based cross normalization calculations. The zero-based cross normalization calculations assign neutral numerals to the statements of the peer groups that do not originally contain statement scores. The neutral numerals are selected by the software program such that the statement weight total of one-hundred percent is maintained for peer groups, without proportionally re-adjusting the statement weights of the remaining statements within any peer group. Therefore, the software program calculates a normalized agendum score. The normalized agendum score is calculated by applying a plurality of mathematical calculations to all the statement scores and the peer group scores, starting from the statements or the peer groups furthest from the statement taxonomy peak. The normalized agendum score is a normalized numerical assessment computed for a particular agendum.

Accordingly, a feature and advantage of the present invention is its ability to calculate single-subject performance scores.

Another feature and advantage of the present invention is its ability to calculate multi-subject performance scores.

Still another feature and advantage of the present invention is its ability to compute categorical performance scores.

Yet another feature and advantage of the present invention is its ability to create holistic performance scores.

Yet still another feature and advantage of the present invention is its ability to allow a user to input various measurement criteria without limit.

A further feature and advantage of the present invention is its ability to organize measurement criteria in a selected taxonomy.

Another feature and advantage of the present invention is its ability to enable users to set standards for an agenda, thereby improving the meaning of the data being measured against the standards of an agenda.

Yet another feature and advantage of the present invention is its ability to enable users to index, compare, and help direct decision-making towards a common purpose.

Still yet another feature and advantage of the present invention is its ability to enable users to weight and rank the importance of the processes and sub-processes of their decision making agenda.

Another feature and advantage of the present invention is its ability to enable users to set dynamic boundaries (infinitely expandable or contractible) for the scope of what is being measured.

Yet another feature and advantage of the present invention is its ability to enable the processing and scoring of disparate data sets.

Still yet another feature and advantage of the present invention is its ability to enable the holistic processing and scoring of data, even when some data inputs are missing.

Another feature and advantage of the present invention is that it enables data aggregation and scoring, which normalizes, harmonizes, weights and sets ranges on any form of data.

Still yet another feature and advantage of the present invention is its ability to provide knowledge of external consequences on decision-making for more successful management.

Another feature and advantage of the present invention is that it enables accountability of users for their decision-making processes through audit trails.

Still yet another feature and advantage of the present invention is its ability to enable users to know the cost of different factors of their decision-making process.

Yet another feature and advantage of the present invention is its ability to enable subjective input data to be utilized in the measurement process.

Another feature and advantage of the present invention is its ability to define measurement criteria without restricting that the measurement criteria are selected from a data set common to all subjects.

Another feature and advantage of the present invention is its ability to allow new subjects that are without re-adjusting the measurement criteria and standards.

Still another feature and advantage of the present invention is its ability to enable comparison of subject performance across disparate measurement criteria.

Yet another feature and advantage of the present invention is that it creates categorical and holistic performance scores in a single measurement process.

Another feature and advantage of the present invention is its ability to utilize a measurement criteria taxonomy for targeted research and targeted input in the decision making process.

Still another feature and advantage of the present invention is that it allows specialists to contribute data in a specific area without understanding an identified problem and without the specialists needing to understand how their contributions are leveraged.

Another feature and advantage of the present invention is its ability to create collaboration across disciplines and areas of concentrated knowledge through the linking of contributions.

Another feature and advantage of the present invention is that it allows the linking and re-use of sub-scores and subjects as data input to another measurement process, such that these inputs would not have to be recreated for a newly started measurement process.

Yet another feature and advantage of the present invention is that it enables the re-use of known data points.

Still another feature and advantage of the present invention is that it enables highly complex measurements to be made with minimal effort through re-use of existing data.

Another feature and advantage of the present invention is that it enables unlimited levels of granularity in the definition of measurement criteria.

These and other features and advantages of the present invention will become more readily apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred Embodiment with reference to the accompanying drawing figures, in which like reference numerals denote similar structure and refer to like elements throughout, and in which:

FIG. 1A is a flowchart illustrating the organization of a statement taxonomy with respect to an agendum, according to a preferred embodiment of a method for generating business intelligence;

FIG. 1B is a flowchart showing a family of statements within a statement taxonomy, according to a preferred embodiment of a method for generating business intelligence;

FIG. 2A is a flowchart illustrating the organization of a subject taxonomy with respect to a subject type, according to a preferred embodiment;

FIG. 2B is a flowchart illustrating the relationship of subjects and attributes, according to a preferred embodiment;

FIG. 2C is a flowchart depicting a family of attributes within a subject taxonomy, according to a preferred embodiment;

FIG. 2D illustrates the components of attributes and the inputs that may be assigned to attributes, according to a preferred embodiment;

FIG. 3A is a flowchart depicting the relationship of components utilized in a method for generating business intelligence, according to a preferred embodiment;

FIG. 3B is a flowchart illustrating a method for generating a statement taxonomy, according to a preferred embodiment;

FIG. 4A is a flowchart illustrating a method for calculating statement weight totals, according to a preferred embodiment;

FIG. 4B illustrates the sources of data utilized for defining statement weights, according to a preferred embodiment;

FIG. 5 is a flowchart depicting a method for generating subject taxonomy, according to a preferred embodiment;

FIG. 6A is a flowchart illustrating a method for calculating attribute weight totals, according to a preferred embodiment;

FIG. 6B illustrates the sources of data utilized for defining attribute weights, according to a preferred embodiment;

FIG. 7A is a flowchart depicting a method of calculating attribute set scores, according to a preferred embodiment;

FIG. 7B is a detailed flowchart illustrating a method for calculating subject scores, according to a preferred embodiment;

FIG. 8A is a flowchart depicting a method for calculating peer group scores, according to a preferred embodiment; and

FIG. 8B is a detailed flowchart illustrating a method for performing holistic calculations and zero-based cross normalization calculations to generate an agendum score, according to a preferred embodiment.

### DETAILED DESCRIPTION OF THE PREFERRED EMBODIMENT OF THE INVENTION

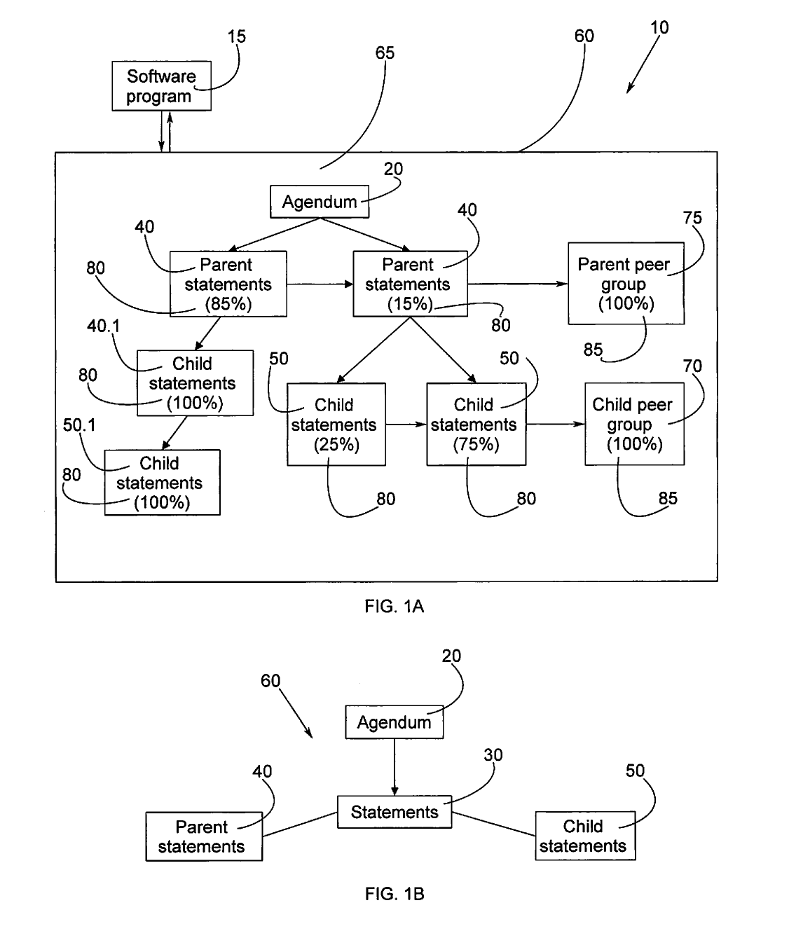

In describing the preferred embodiment of the present invention, as illustrated in FIGS. 1-8B, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1A-1B, the present invention in a preferred embodiment is method for generating business intelligence 10, wherein method for generating business intelligence 10 comprises software program 15 and agendum 20, wherein agendum 20 comprises statements 30, and wherein agendum 20 is a goal and/or an objective. Statements 30 refer to one or more declarative sentences which are organized hierarchically under agendum 20, wherein statements 30 linked to agendum 20 for the purposes of supporting the achievement of agendum 20. Statements 30 further comprise parent statements 40, wherein parent statements 40 are declarative sentences that beget other declarative sentences which are organized hierarchically under agendum 20, and wherein parent statements 40 support agendum 20. Statements 30 further comprise child statements 50, wherein child statements 50 are declarative sentences that are preceded hierarchically by parent statements 40, and wherein child statements 50 are derived from parent statements 40. Method for generating business intelligence 10 further comprises statement taxonomy 60, wherein statement taxonomy 60 is a relational hierarchy of agendum 20 and statements 30, and wherein statements 30 are descendants of agendum 20, and wherein agendum 20 is at the statement taxonomy peak 65. Statement taxonomy 60 comprises child peer groups 70 and parent peer groups 75, wherein child and parent peer groups 70, 75, respectively comprise at least two of child statements 50 sharing a common preceding parent statement 40, or alternatively, at least two of parent statements 40 sharing a common preceding agendum 20. Statements 30 within statement taxonomy 60 comprise statement weights 80, wherein statement weight total 85 is a sum total of statement weights 80 of each statement 30 within selected child or parent peer groups 70, 75, and wherein statement weight total 85 equals one-hundred percent. It will be recognized by those skilled in the art that statement taxonomy 60 may comprise limitless parent statements 40 and child statements 50, wherein additional parent statements 40 and child statements 50 each comprise statement weights 80 and may comprise parent or child peer groups 75, 70. Further, child statements 50.1 may branch from other child statements 50, wherein, under these circumstances, child statements 50 are parent statements 40.1 to child statements 50.1, while still maintaining the original hierarchy of statement taxonomy 60.

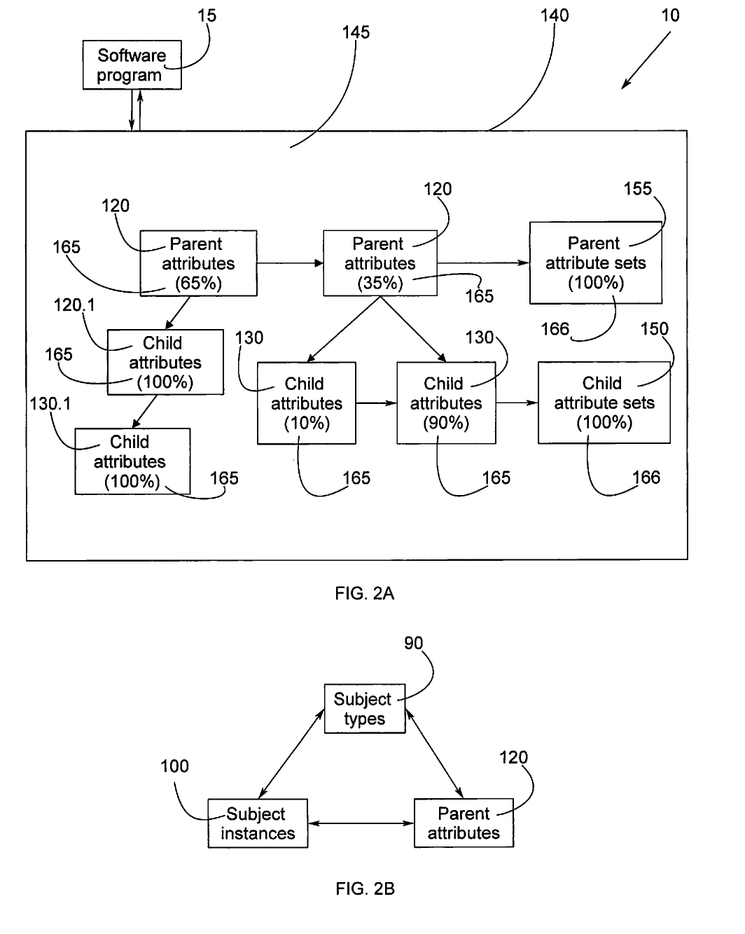

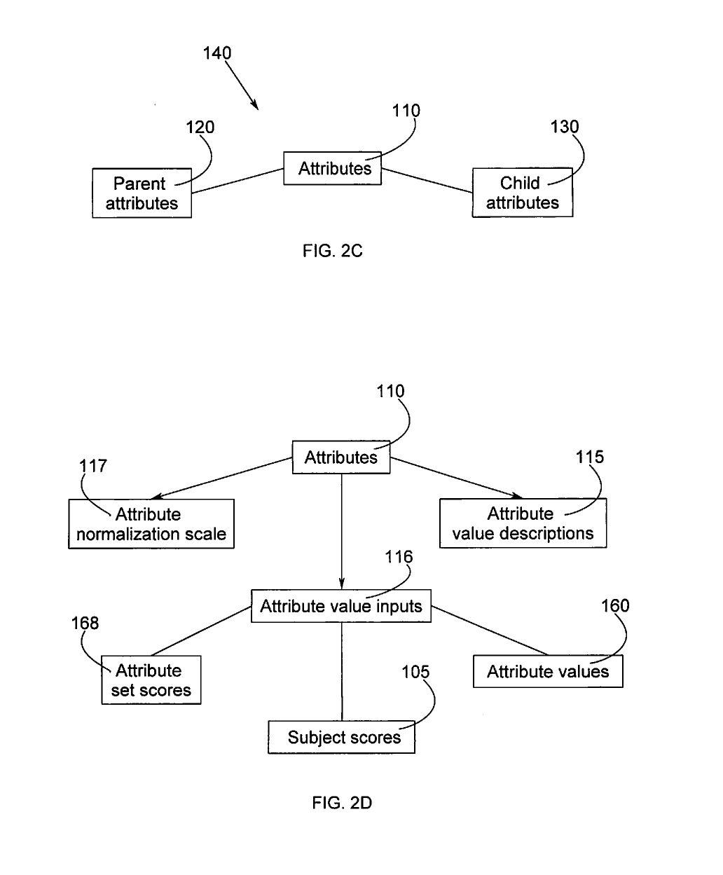

Referring now to FIGS. 2A-2D, method for generating business intelligence 10 further comprises subject types 90 and subject instances 100, wherein subject types 90 comprise a category of a person, place or object, and wherein subject instances 100 are an occurrence of subject types 90. Subject instances 100 comprise attribute values 160, wherein attribute values 160 are the actual inputted and/or measured numerical data for selected attributes 110. Attributes 110 further comprise parent attributes 120, wherein parent attributes 120 are organized hierarchically under subject types 90, and wherein subject types 90 are supported by parent attributes 120. Attributes 110 further comprise child attributes 130, wherein child attributes 130 are preceded hierarchically by parent attributes 120, and wherein child attributes 130 are derived from parent attributes 120. Method for generating business intelligence 10 further comprises subject taxonomy 140, wherein subject taxonomy 140 is a relational hierarchy of subject types 90 and attributes 110, and wherein attributes 110 are descendants of subject types 90, and wherein subject instances 100 are an occurrence of subject types 90, and wherein parent attributes 120 are at the top of subject taxonomy peak 145. Subject taxonomy 140 comprises child attribute sets 150, wherein child attribute sets 150 are a group formed from at least two of child attributes 130 sharing a common preceding parent attribute 120. Subject taxonomy 140 further comprises parent attribute sets 155, wherein parent attribute sets 155 are a group formed from at least two of parent attributes 120 sharing a common subject type 90. Subject types 90 comprise attributes 110, wherein attributes 110 comprise attribute value descriptions 115 and attribute value inputs 116, and wherein attributes 110 may further selectively comprise attribute normalization scale 117. Attribute value descriptions 115 are indicia representing attribute values 160, wherein attribute value descriptions 115 comprise, for exemplary purposes only, and not limited to, text, images, and/or movies through which attribute values 160 are defined. Attribute value inputs 116 comprise entry fields, wherein numeric values may be inputted utilizing software program 15 for attributes 110, and wherein attribute value inputs 116 may comprise attribute values 160, subject scores 105 or attribute set scores 168 (as best shown in FIG. 2D), and wherein subject scores 105 are calculated scores for subject instances 100, and wherein attribute set scores 168 are calculated scores for child and/or parent attribute sets 150, 155. Attribute normalization scale 117 is a range of acceptable numeric values inputted into software program 15 for attribute values 160.

Referring back to FIG. 2A, attributes 110 within subject taxonomy 140 comprise attribute weights 165, wherein attribute weight total 166 is a sum total of attribute weights 165 of each attribute 110 within selected child or parent attribute sets 150, 155, and wherein attribute weight total 166 equals one-hundred percent. It will be recognized by those skilled in the art that subject taxonomy 140 may comprise limitless parent attributes 120 and child attributes 130, wherein additional parent attributes 120 and child attributes 130 each comprise attribute weights 165 and may comprise parent or child attribute sets 155, 150. Further, child attributes 130.1 may branch from other child attributes 130, wherein, under these circumstances, child attributes 130 are parent attributes 120.1 to child attributes 130.1, while still maintaining the original hierarchy of subject taxonomy 140. Additionally, subject types 90 may branch from other attributes 110, wherein, under these circumstances, attributes 110 accept subject scores 105 for an attribute value input 116 in place of attribute values 160, while still maintaining the original hierarchy of subject taxonomy 140.

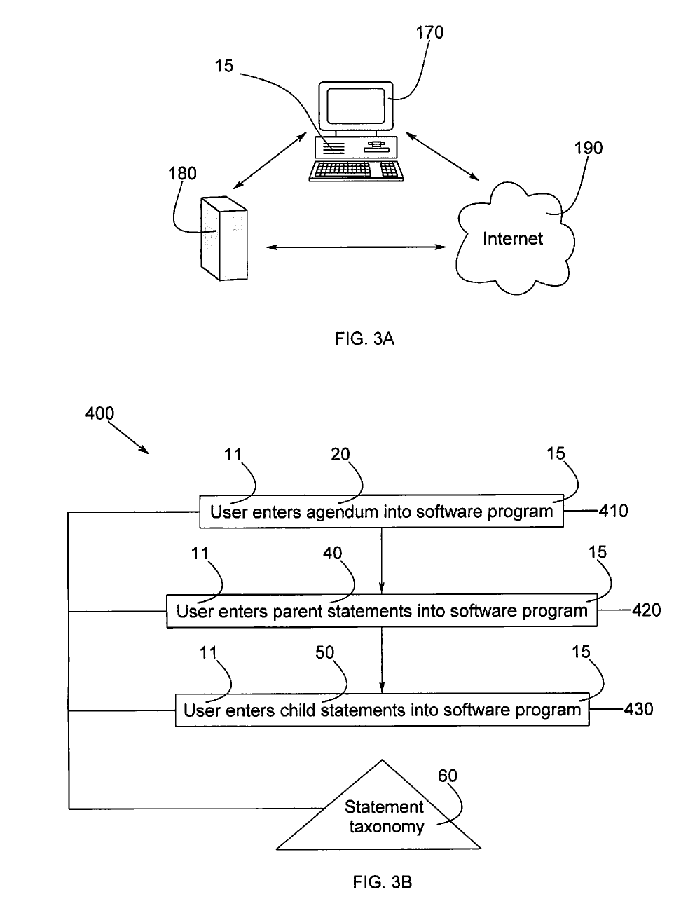

Referring now to FIGS. 3A-3B, user 11 establishes statement taxonomy 60 via process 400, wherein process 400 requires utilizing software program 15 on computer 170 to access database 180, and wherein database 180 may be stored off-line locally on computer 170 or on-line on Internet 190, and wherein computer 170, database 180 and Internet 190 are in electrical or wireless communication. User 11 enters agendum 20 into software program 15 via step 410. User 11 then enters parent statements 40 into software program 15 via step 420, wherein parent statements 40 support the achievement of agendum 20. Subsequently, user 11 inputs child statements 50 into software program 15 via step 430, wherein child statements 50 are derived from parent statements 40. Accordingly, step(s) 410, 420, and/or 430 collectively create the hierarchically order of statement taxonomy 60 with respect to agendum 20, wherein statements 30 that directly support the achievement of agendum 20 are classified as parent statements 40, and wherein statements 30 that are derived from parent statements 40 are classified as child statements 50.

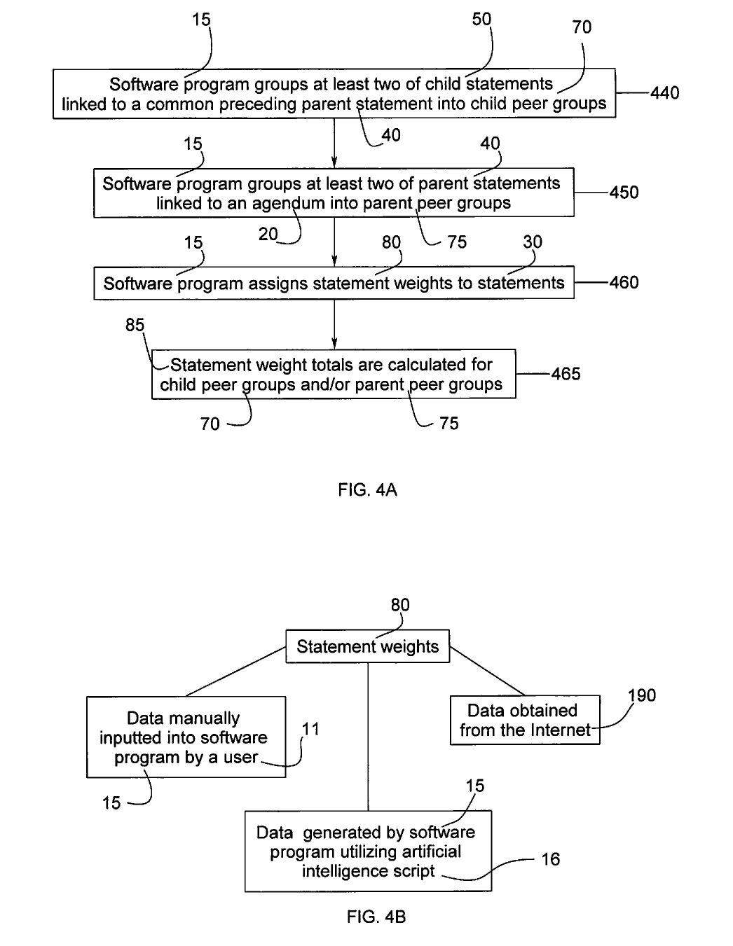

Referring now to FIGS. 4A-4B, software program 15 automatically groups via step 440 at least two of child statements 50 linked to a common preceding parent statement 40 into child peer groups 70. Similarly, software program 15 automatically groups via step 450 at least two of parent statements 40 linked to agendum 20 into parent peer groups 75. Software program 15 then assigns statement weights 80 to statements 30 via step 460, wherein statement weights 80 may be assigned by software program 15 through autonomous calculations conducted by artificial intelligence script 16 or alternatively though manual input of user 11. Statement weight total 85 is then calculated for child and/or parent peer groups 70, 75 via step 465. As best shown in FIG. 4B, statement weights 80 may comprise data manually inputted by user 11 into software program 15, data generated by software program 15 utilizing artificial intelligence script 16, data obtained from Internet 190, and combinations thereof. It will be recognized by those skilled in the art that statement weights 80 may be obtained from other sources, such as, for exemplary purposes only, through community voting methods.

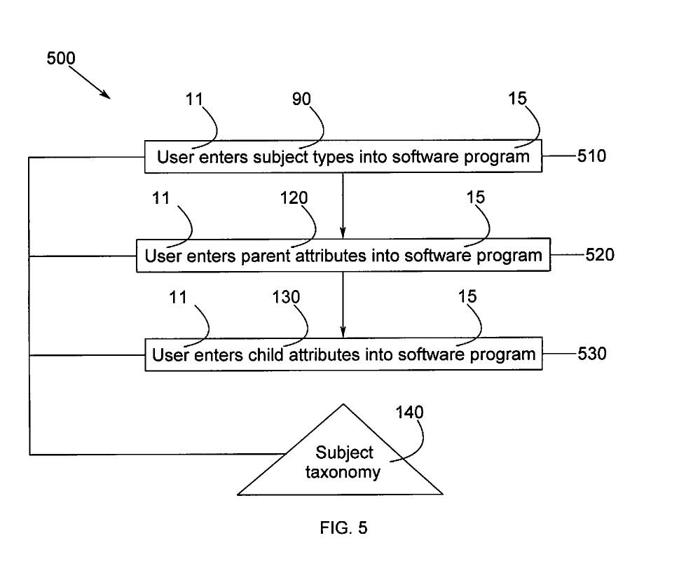

Referring now to FIGS. 5 and 3A, user 11 establishes subject taxonomy 140 via process 500, wherein process 500 requires utilizing software program 15 on computer 170 to access database 180, and wherein database 180 may be stored off-line locally on computer 170 or on-line on Internet 190, and wherein computer 170, database 180 and Internet 190 are in electrical or wireless communication, as best shown in FIG. 3A. User 11 enters subject types 90 into software program 15 via step 510. Subsequently, user 11 inputs parent attributes 120 into software program 15 via step 520, wherein parent attributes 120 support subject types 90. User 11 then inputs child attributes 130 into software program 15 via step 530, wherein child attributes 130 are derived from parent attributes 120. Accordingly, step(s) 510, 520, and/or 530 collectively create the hierarchically order of subject taxonomy 140 with respect to subject types 90, wherein attributes 110 that directly support subject types 90 are classified as parent attributes 120, and wherein attributes 110 that derive from parent attributes 120 are classified as child attributes 130.

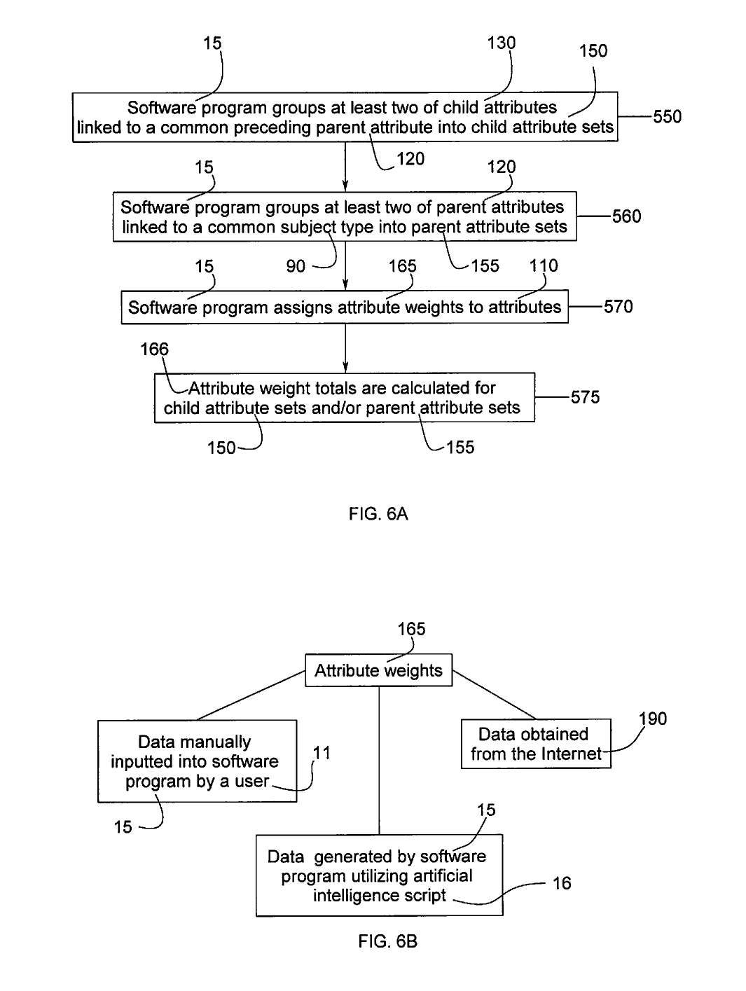

Referring now to FIGS. 6A-6B, software program 15 automatically groups at least two of child attributes 130 linked to a common preceding parent attribute 120 into child attribute sets 150 via step 550. Similarly, software program 15 automatically groups at least two of parent attributes 120 linked to a common subject type 90 into parent attribute sets 155 via step 560. Software program 15 then assigns attribute weights 165 to attributes 110 via step 570, wherein attribute weight total 166 is calculated for child and/or parent attribute sets 150,155 via step 575. As best shown in FIG. 6B, attribute weights 165 may comprise data manually inputted by user 11 into software program 15, data generated by software program 15 utilizing artificial intelligence script 16, data obtained from Internet 190, and combinations thereof. It will be recognized by those skilled in the art that attribute weights 165 may be obtained from other sources, such as, for exemplary purposes only, through community voting methods.

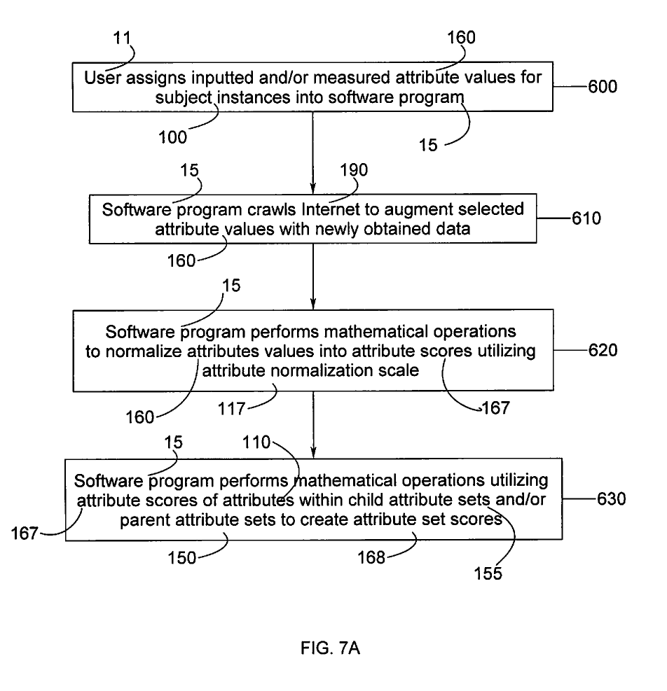

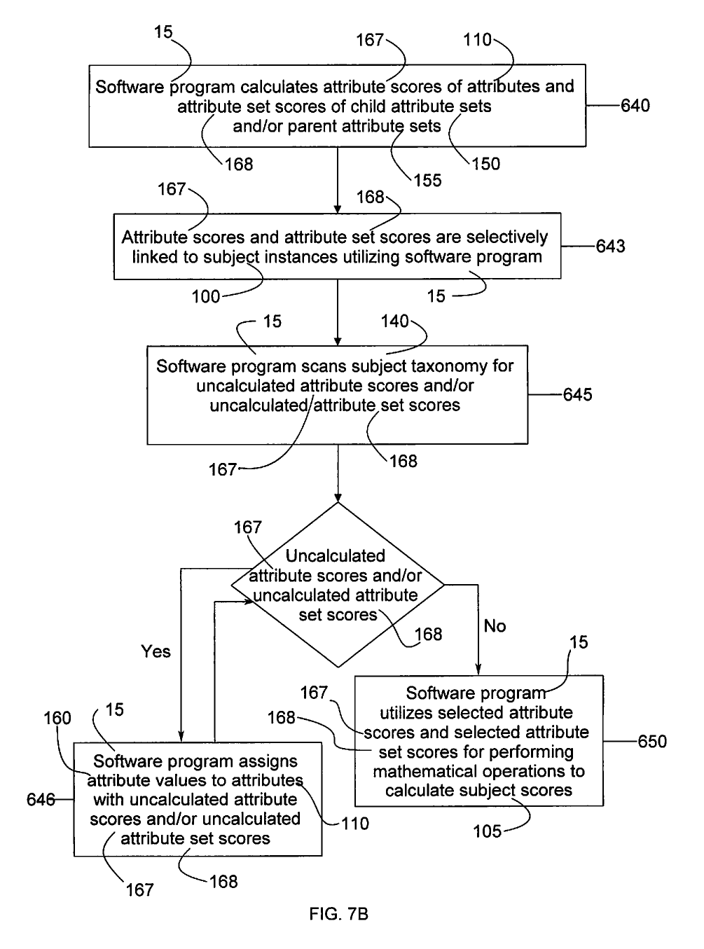

Referring now to FIG. 7A, user 11 assigns via step 600, inputted or measured attribute values 160 for subject instances 100 into software program 15. Alternatively, software program 15 automatically crawls Internet 190 to augment selected attribute values 160 with newly obtained data via step 610. Subsequently, attributes values 160 are normalized via step 620 through mathematical operations utilizing attribute normalization scale 117, thereby generating attribute scores 167. Attribute scores 167 of attributes 110 within child and/or parent attribute sets 150, 155 are then operated on mathematically via step 630, such as, for exemplary purposes only, being summed together to create attribute set scores 168, wherein attribute set scores 168 are a singular numeric value that represents all attributes 110 within selected child and/or parent attribute sets 150, 155.

Referring now to FIG. 7B, software program 15 calculates via step 640 attribute scores 167 of attributes 110 and attribute set scores 168 of child and/or parent attribute sets 150, 155, wherein attribute scores 167 and attribute set scores 168 are linked to selected subject instances 100 via step 643, and wherein subject instances 100 may selectively utilize attribute scores 167 and attribute set scores 168. Software program 15 scans subject taxonomy 140 via step 645, for uncalculated attribute scores 167 and uncalculated attribute set scores 168 of selected attributes 110 or of selected child and/or parent attribute sets 150,155, respectively. If uncalculated attribute scores 167 and/or uncalculated attribute set scores 168 are detected, then software program 15 selectively assigns attribute values 160 via step 646 to attributes 110 with uncalculated attribute scores 167 or uncalculated attribute set scores 168. If no uncalculated attribute scores 167 and attribute set scores 168 are detected, then software program 15 utilizes selected attribute scores 167 and selected attribute set scores 168 for performing mathematical operations via step 650 to calculate subject scores 105, wherein a plurality of mathematical calculations may be applied to selected attribute scores 167 and attribute set scores 168, and wherein subject scores 105 are numerical assessments computed for subject instances 100.

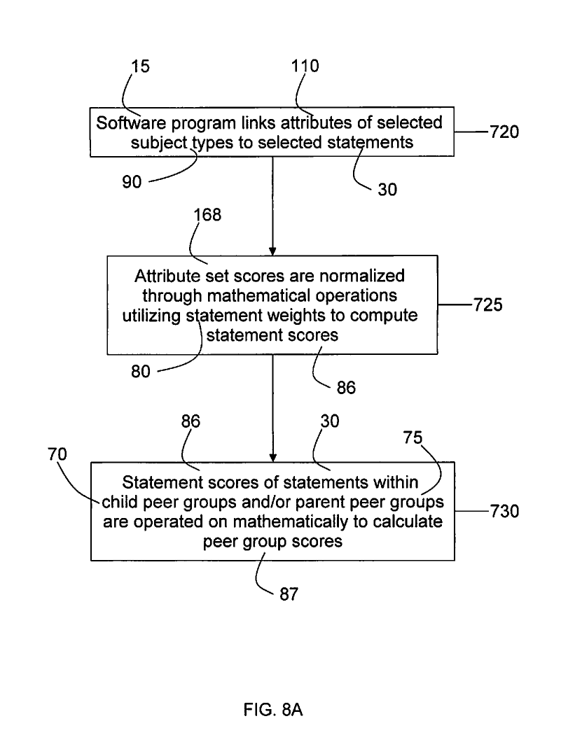

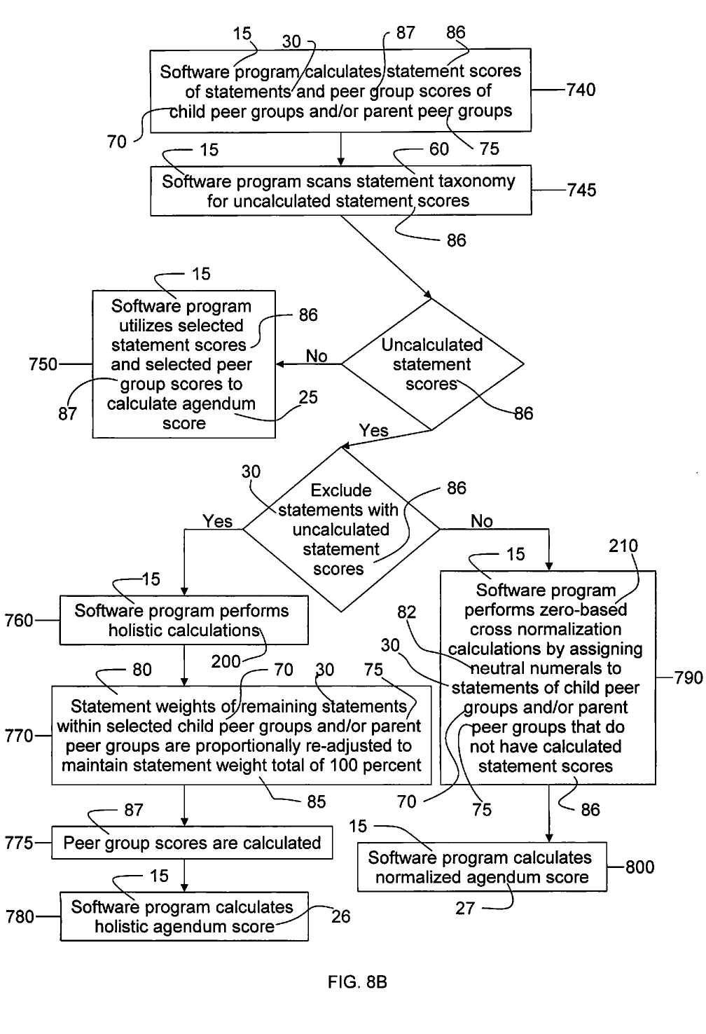

Referring now to FIG. 8A, user 11 may selectively utilize software program 15 to link selected attributes 110 of subject types 90 to selected statements 30 via step 720, wherein statements 30 may then selectively utilize attribute set scores 168, and wherein attribute set scores 168 linked to statements 30 are normalized through mathematical operations via step 725, such as, for exemplary purposes only, multiplying by statement weights 80 to compute statement scores 86. Statement scores 86 of statements 30 within child and/or parent peer groups 70, 75 are then operated on mathematically via step 730, such as, for exemplary purposes only, being summed together to calculate peer group scores 87, wherein peer groups scores 87 are a singular numeric value that represents all statements 30 within selected child and/or parent peer groups 70, 75.

Referring now to FIG. 8B, software program 15 calculates via step 740 statement scores 86 of statements 30 and peer group scores 87 of child and/or parent peer groups 70, 75, wherein statement scores 86 and peer group scores 87 are calculated numeric values to be utilized by agendum 20. Software program 15 scans statement taxonomy 60 via step 745 for uncalculated statement scores 86. If no uncalculated statement scores 86 are detected, then software program 15 utilizes selected statement scores 86 and selected peer group scores 87 to calculate agendum score 25 via step 750, wherein a plurality of mathematical calculations may be applied to selected statement scores 86 and peer group scores 87 starting from statements 30 or child and/or parent peer groups 70, 75 furthest from statement taxonomy peak 65, and wherein agendum score 25 is a numerical assessment computed for a particular agendum 20. Alternatively, if statements 30 of child and/or parent peer groups 70, 75 do not contain statement scores 86, then software program 15 selectively performs holistic calculations 200 via step 760, wherein holistic calculations 200 exclude statements 30 that do not originally contain statement scores 86 from any further mathematical calculations, and wherein statements 30 that do not contain statement scores 86 will be ignored by software program 15. Accordingly, statement weights 80 of remaining statements 30 within selected child and/or parent peer groups 70, 75 are proportionally re-adjusted via step 770 to maintain statement weight total 85 of one-hundred percent for child and/or parent peer groups 70, 75. Subsequently, peer group scores 87 are re-calculated via step 775. Therefore, software program 15 calculates holistic agendum score 26 via step 780, wherein holistic agendum score 26 is calculated by applying a plurality of mathematical calculations to all statement scores 86 and peer group scores 87 starting from statements 30 or child and/or parent peer groups 70, 75 furthest from statement taxonomy peak 65, and wherein holistic agendum score 26 is an adjusted numerical assessment computed for a particular agendum 20. Alternatively, if statements 30 of child and/or parent peer groups 70, 75 do not contain statement scores 86, then software program 15 selectively performs zero-based cross normalization calculations 210 via step 790, wherein zero-based cross normalization calculations 210 assign neutral numerals 82 to statements 30 of child and/or parent peer groups 70, 75 that do not originally contain statement scores 86, and wherein neutral numerals 82 are selected by software program 15 such that statement weight total 85 of one-hundred percent may be maintained for child and/or peer groups 70, 75, without proportionally re-adjusting statement weights 80 of remaining statements 30 within child and/or parent peer groups 70, 75. Therefore, software program 15 calculates normalized agendum score 27 via step 800, wherein normalized agendum score 27 is calculated by applying a plurality of mathematical calculations to all statement scores 86 and peer group scores 87 starting from statements 30 or child and/or parent peer groups 70, 75 furthest from statement taxonomy peak 65, and wherein normalized agendum score 27 is a normalized numerical assessment computed for a particular agendum 20.

### Examples

An example of an agendum is “hire the best pool of employees.” An example of statements is “find a candidate who has the minimum number of years of direct experience” or “find a candidate who has the minimum education required. An example of a parent statement is “keep employee moral high” or “find a candidate whose personality fits our company culture.” An example of a child statement is “offer employees networking and social events” or “find a candidate who has the minimum number of years of direct experience.” A sibling statement of the child statements is, for example, “offer employees networking and social events” or “offer employees project support with interns.” An example of a subject is “a specific candidate.” An example of a subject type is “employee.” An example of a subject instance is “John Smith.” An example of an attribute is “level of education.” An example of an attribute value is “high school.” An example of a parent attribute is “number of years you have direct work experience.” An example of a child attribute is “number of years of work experience.”

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A method for generating business intelligence, said method comprising the steps of:
creating a database;
contributing data into said database via a computer;
assigning numeric values to said data via a computer; and
calculating scores from said data, wherein said scores are representative of said data.

2. The method of claim 1, wherein said database is in communication with said computer via a software program, and wherein said software program may access said database from the group consisting of locally on a computer, over the Internet, and combinations thereof.

3. The method of claim 1, wherein said data is selected from the group consisting of agenda, statements, subject types, attributes and combinations thereof.

4. The method of claim 3, wherein said agendum comprises an objective.

5. The method of claim 4, wherein said statements support said agendum.

6. The method of claim 5, wherein said statements generate statement taxonomy, and wherein said statement taxonomy comprises statements selected from the group consisting of parent statements, child statements and combinations thereof.

7. The method of claim 6, wherein said parent statements are derived from said agenda, and wherein said child statements are derived from said parent statements.

8. The method of claim 7, wherein said parent statements sharing a common agendum may be grouped together to form parent peer groups.

9. The method of claim 8, wherein said child statements sharing a common parent statement may be grouped together to form child peer groups.

10. The method of claim 9, wherein said statements in said statement taxonomy are assigned statement weights by said software program.

11. The method of claim 10, wherein said statements in said statement taxonomy are assigned statement weights by a user utilizing said software program.

12. The method of claim 11, wherein said statement weights for said statements within said parent peer groups are operated on mathematically to create statement weight totals, and wherein said statement weight totals equal one-hundred percent.

13. The method of claim 12, wherein said statement weights for said statements within said child peer groups are operated on mathematically to create statement weight totals, and wherein said statement weight totals equal one-hundred percent.

14. The method of claim 3, wherein said attributes generate a subject taxonomy, and wherein said subject taxonomy comprises said attributes selected from the group consisting of parent attributes, child attributes and combinations thereof.

15. The method of claim 14, wherein said parent attributes are derived from said subject types, and wherein said child attributes are derived from said parent attributes.

16. The method of claim 15, wherein said parent attributes sharing a common subject type may be grouped together to form parent attribute sets.

17. The method of claim 16, wherein said child attributes sharing a common parent attribute may be grouped together to form child attribute sets.

18. The method of claim 17, wherein said attributes in said subject taxonomy are assigned attribute weights by said software program.

19. The method of claim 18, wherein said attributes in said subject taxonomy are assigned attribute weights by a user utilizing said software program.

20. The method of claim 19, wherein said attribute weights for said attributes within said parent attribute sets are operated on mathematically to create attribute weight totals, and wherein said attribute weight totals equal one-hundred percent.

21. The method of claim 20, wherein said attribute weights for said attributes within said child attribute sets are operated on mathematically to create attribute weight totals, and wherein said attribute weight totals equal one-hundred percent.

22. The method of claim 21, wherein said attributes are selected from the group consisting of attribute value inputs, attribute value descriptions, attribute normalization scales and combinations thereof.

23. The method of claim 22, wherein said attribute value inputs are selected from the group consisting of attribute values, subject scores, attribute set scores and combinations thereof.

24. The method of claim 23, wherein said attribute values comprise inputted numerical indicators for selected attributes.

25. The method of claim 24, wherein said attribute values comprise measured numerical indicators for selected attributes.

26. The method of claim 25, wherein said attribute value descriptions comprise indicia defining said attribute values.

27. The method of claim 26, wherein said attribute normalization scales comprise ranges of acceptable numerical indicators inputted into said software program for selected attribute values.

28. The method of claim 27, wherein said subject scores comprise calculated scores for subject instances.

29. The method of claim 28, wherein said subject instances comprise occurrences of said subject types.

30. The method of claim 29, wherein said attribute set scores comprise calculated scores derived from said child and parent attribute sets.

31. A method for generating business intelligence comprising the steps of:
entering an agendum into a software program, wherein said agendum comprises an objective;
entering parent statements into said software program, wherein said parent statements are linked to said agendum; and
entering child statements into said software program, wherein said child statements are linked to said parent statements.

32. The method of claim 31, said method further comprising the steps of:
selecting parent statements;
linking said selected parent statements into parent peer groups, wherein said agendum is common to each of said selected parent statements, and wherein said parent peer groups comprise at least two of said selected parent statements grouped together;
selecting child statements;
linking said selected child statements into child peer groups, wherein said parent statement is common to each of said selected child statements, and wherein said child peer groups comprise at least two of said selected child statements grouped together;
assigning statement weights to said parent statements, wherein said statement weights are selected from the group consisting of data inputted by the user, data from the Internet, data previously stored in said software program and combinations thereof;
assigning said statement weights to said child statements;
calculating statement weight totals for said parent peer groups, wherein said statement weights for said parent statements within said parent peer groups are operated on mathematically to calculate said statement weight totals; and
calculating statement weight totals for said child peer groups, wherein said statement weights for said child statements within said child peer groups are operated on mathematically to calculate said statement weight totals.

33. The method of claim 32, said method further comprising the steps of:
entering subject types into said software program;
entering parent attributes into said software program; and
entering child attributes into said software program.

34. The method of claim 33, said method further comprising the steps of:
selecting child attributes;
linking said selected child attributes into child attribute sets, wherein said parent attribute is common to each of said selected child attributes, and wherein said child attribute sets comprise at least two of said selected child attributes grouped together;
selecting parent attributes;
linking said selected parent attributes into parent attribute sets, wherein said subject type is common to each of said selected parent attributes, and wherein said parent attribute sets comprise at least two of said selected parent attributes grouped together;
assigning attribute weights to said parent attributes, wherein said attribute weights are selected from the group consisting of data inputted by the user, data from the Internet, data previously stored in said software program, and combinations thereof;
assigning said attribute weights to said child attributes;
calculating attribute weight totals for said parent attribute sets, wherein said attribute weights for said parent attributes within said parent attribute sets are operated on mathematically to calculate said attribute weight totals; and
calculating attribute weight totals for said child attribute sets, wherein said attribute weights for said child attributes within said child attribute sets are operated on mathematically to calculate said attribute weight totals.

35. The method of claim 34, said method further comprising the steps of:
assigning attribute values for subject instances into said software program via the manual input of a user, wherein said attribute values are numerical indicators selected from the group consisting of inputted numeric values, measured numeric values, and combinations thereof, for said parent attributes and said child attributes, and wherein said subject instances comprise occasions of said subject types;
assigning said attribute values for said subject instances via the automatic crawling of the Internet by said software program;
normalizing said attribute values through mathematical operations utilizing an attribute normalization scale to generate attribute scores, wherein said attribute normalization scale is a range of acceptable numerical indicators inputted into said software program as said attribute values, and wherein said attribute scores are normalized numeric values for said parent attributes and said child attributes;
operating on mathematically the attribute scores of said parent attributes within said parent attribute sets and said child attributes within said child attribute sets to calculate attribute set scores, wherein said attribute set scores are a singular calculated numeric value for said selected parent and child attribute sets.

36. The method of claim 35, said method further comprising the steps of:
calculating said attribute scores;
calculating said attribute set scores;
scanning for uncalculated attribute scores and uncalculated attribute set scores via said software program;
assigning said attribute values to said parent attributes and said child attributes with said uncalculated attribute scores;
assigning said attribute values to said parent attributes and said child attributes within said parent attribute sets and within said child attribute sets with said uncalculated attribute set scores; and
operating on mathematically the said attribute scores and said attribute set scores to calculate subject scores, wherein said subject scores are calculated numeric values for said subject instances.

37. The method of claim 36, said method further comprising the steps of:
selecting subject types;
selecting parent statements;
selecting child statements;
linking said selected subject types to said selected parent statements and said selected child statements, wherein said selected subject types comprise said parent attributes and said child attributes, and wherein said parent attributes and said child attributes contribute their said attribute scores;
linking said selected subject types to said selected parent statements and said selected child statements, wherein said selected subject types comprise said parent attribute sets and said child attribute sets, and wherein said parent attribute sets and said child attribute sets contribute their said attribute set scores;
normalizing said attribute set scores linked to said selected parent statements and said selected child statements through mathematical operations utilizing said statement weights to compute statement scores, wherein said statement scores are calculated numeric values for said selected parent statements and said selected child statements; and
operating on mathematically the said statement scores of said parent statements within said parent peer groups and said child statements within said child peer groups to calculate peer group scores, wherein said peer group scores are a singular calculated numeric value for said parent peer groups and said child peer groups.

38. The method of claim 37, said method further comprising the step of:
scanning for uncalculated said statement scores and said peer group scores via said software program.

39. The method of claim 38, said method further comprising the steps of:
selecting parent statements with uncalculated statement scores of selected parent peer groups with uncalculated peer group scores;
selecting child statements with uncalculated statement scores of selected child peer groups with uncalculated peer group scores;
excluding said selected parent statements of said selected parent peer groups and said selected child statements of said selected child peer groups, wherein said software program ignores said selected parent statements and said selected child statements;
performing holistic calculations utilizing said selected parent peer groups and said selected child peer groups, wherein said statement weights of said parent statements and said child statements within said selected parent peer groups and said selected child peer groups are proportionally re-adjusted to maintain said statement weight total of one-hundred percent;
calculating said peer group scores; and
calculating holistic agendum score, wherein said holistic agendum score is a numerical indicator of said agendum based on said holistic calculations.

40. The method of claim 38, said method further comprising the steps of:
selecting parent statements with uncalculated statement scores of selected parent peer groups with uncalculated peer group scores;
selecting child statements with uncalculated statement scores of selected child peer groups with uncalculated peer group scores;
including said selected parent statements of said selected parent peer groups and said selected child statements of said selected child peer groups if said parent statements and said child statements are missing said statement scores, wherein said software program utilizes said selected parent statements and said selected child statements ;
performing zero-based cross normalization calculations utilizing said selected parent statements and said selected child statements, wherein said zero-based cross normalization calculations assign a neutral numeral to said selected parent statements and said selected child statements, and wherein said neutral numeral is assigned to maintain said statement weight total of one-hundred percent; and
calculating normalized agendum score, wherein said normalized agendum score is a numerical indicator of said agendum based on said zero-based cross normalization calculations.
